(19) United States
(12) Patent Application Publication
(10) Pub. No.: US 2026/0105843 A1
(43) Pub. Date: Apr. 16, 2026

(54) NON-TRANSITORY MACHINE-READABLE STORAGE MEDIUM FOR DETERMINING PARKING SPACE AVAILABILITY

(71) Applicant: OBSCHESTVO S OGRANICHENNOY OTVETSTVENNOSTYU "PARCORP", MOSCOW (RU)

(72) Inventors: Maksim Olegovich VARNIAGA, Ekaterinburg (RU); Maksim Borisovich BELOPUKHOV, Ramenskoye (RU); Elizaveta Aleksandrovna ROZHKOVA, Moscow (RU); Aleksandr Andreevich LARIN, Moscow (RU)

(21) Appl. No.: 19/224,626

(22) Filed: May 30, 2025

(30) Foreign Application Priority Data
Oct. 10, 2024 (RU) 2024130491

(51) Int. Cl. G08G 1/14; G06V 10/82; G06V 20/52

(52) U.S. Cl. CPC G08G 1/146; G06V 10/82; G06V 20/52; G06V 2201/08

(57) ABSTRACT

The technical solution relates to the field of information technology, more specifically, to methods and techniques for determining the availability of parking spaces. There is a need to simplify the methods, techniques and systems for determining the availability of parking spaces in order to reduce the consumption of computing resources and at the same time ensure accurate and reliable determination of the availability of a parking space. The technical result achieved when implementing the claimed technical solution, in addition to implementing the product and/or method of its purpose, is to increase the reduction of the resources required to determine the availability of a parking space, as well as to increase the accuracy of determining the availability of a parking space while eliminating recognition errors and ensuring the ability to determine the availability of a parking space even if it is occupied by an object not intended for placement in a parking space. In some aspects, another technical result achieved is also an increase in road safety.

### FIELD OF INVENTION

The present invention relates to information technologies, particularly to methods and ways of determining whether a parking space is available.

### DESCRIPTION OF THE RELATED ART

There are various known methods for determining whether a parking space is available. Usually, such methods involve marking a parking space, determining the outline of a vehicle, and matching the outline with the marking of the parking space in order to calculate whether it is occupied or not. Often, the instruments used include specially configured environmental sensors, such as, but not limited to, cameras, radars, lidars, and the like. In general, the conventional systems for determining parking space availability include either those mounted directly on vehicles and thus mainly used to aid in automatic parking, or those used for remote reading of information about parking space availability in a specific area, which are thus preferably employed as part of navigation means, and/or parking space reservation and/or rental means, or as an addition to them. In addition, but not limited to, in the first case, it is not possible to obtain information in advance on whether a given parking lot has available parking spaces, which prevents one from planning an efficient route or reserve and/or rent a parking space. At the same time, but not limited to, in the second case, complex systems with multiple sensors and devices are usually used, which require resource-intensive calculations of spaces and outlines in order to get an unambiguous answer as to whether the given parking space is occupied or not.

At the same time, patent document U.S. Pat. No. 8,923,565B1, published on Dec. 30, 2014 [D1], discloses a method for detecting parked vehicles based on edge detection. For each parking space, its boundary comprises an exposed edge, which is not occluded by any parked vehicle. Its primary detected edges are the detected edges that are substantially parallel to the exposed edge. A parking space is detected as occupied if its primary detected edges satisfy at least one of these conditions: (1) their total number is more than a pre-determined minimum number; and/or, (2) their total length is more than a pre-determined minimum length. The solution known from D1 mainly consists in determining an area for each parking space, in which a vehicle has to be detected, which is complicated in itself and requires an accurate detection of edges of a vehicle to form the boundary of the parking space, which inevitably leads to recognition errors, when the parking space is occupied with a non-standard vehicle, such as small car or a motorcycle, or when the parking space is occupied with a vehicle that does not get into the area of recognition or is positioned at an angle that does not provide any parallel lines for recognition. Besides, when the solution of D1 is used, recognition errors are inevitable, when a random regularly-shaped object gets into the area of recognition, which is not a vehicle, but still provides parallel lines for recognition, such as, for example, but not limited to, a shadow of another vehicle, or a building, or the like. Besides, the solution of D1 does not allow to determine if a parking space is occupied, whereas it is actually occupied by a foreign object, which is not supposed to occupy it.

Therefore, there is a need in the field to simplify the methods and systems for determining parking space availability in order to reduce the amount of computing resources required while allowing to accurately and reliably determine whether a parking space is available.

The solution disclosed in D1 can be considered the closest prior art to the claimed invention.

### SUMMARY OF THE INVENTION

The technical problem to be solved by the claimed invention is to provide a method, a device, a system, a motor vehicle, and a computer-readable medium that do not possess the drawbacks of the prior art and thus make it possible to reduce the amount of computing resources required to determine whether a parking space is available, as well as to improve the accuracy of determining whether a parking space is available and at the same time eliminate errors of recognition and make it possible to determine whether a parking space is available, even if the space is occupied by an object that is not supposed to occupy it. Another technical problem to be solved by the claimed invention is to provide a product and/or a method and/or an implementation that expand the available technical means, namely methods for determining whether a parking space is available.

The objective of the claimed invention, in addition to the product and/or method fulfilling their purpose, is to reduce the amount of resources required to determine whether a parking space is available, as well as to improve the accuracy of determining whether a parking space is available and at the same time eliminate errors of recognition and make it possible to determine whether a parking space is available, even if the space is occupied by an object that is not supposed to occupy it. In some aspects of the claimed invention, the objectives also include the provision of increased road safety.

The objective of the present invention is achieved by a non-transitory machine-readable storage medium containing a program code, which, when executed by at least one processor of at least one computer device, allows to perform a method for determining whether a parking space is available; wherein the method for determining whether a parking space is available is executed by at least one processor of at least one computer device and comprises at least the following steps: obtaining an environment frame; obtaining layout coordinates of a parking space area in the environment frame; obtaining vehicle outline coordinates in the environment frame; obtaining coordinates of a key point of the vehicle outline; and matching the coordinates of the key point of the vehicle outline with the layout coordinates of the parking space area.

### BRIEF DESCRIPTION OF THE DRAWINGS

Exemplary embodiments of the present utility model are described in further detail below with references made to the attached drawings, included herein by reference:

FIG. 1 illustrates an exemplary diagram for method 100 for determining whether a parking space is available.

FIG. 2 illustrates an exemplary diagram for system 200 for determining whether a parking space is available and an exemplary processed environment frame.

FIG. 3 illustrates an exemplary diagram for method 300 for generating a graphical user interface and a diagram for system 400 for generating a graphical user interface.

### DETAILED DESCRIPTION OF THE PREFERRED EMBODIMENTS

According to a preferred embodiment of the present invention, there is provided a method for determining whether a parking space is available, executed by at least one processor of at least one computer device, the method comprising at least the following steps: obtaining an environment frame; obtaining layout coordinates of a parking space area in the environment frame; obtaining vehicle outline coordinates in the environment frame; obtaining coordinates of a key point of the vehicle outline; and matching the coordinates of the key point of the vehicle outline with the layout coordinates of the parking space area.

According to an exemplary embodiment of the present invention, there is provided a disclosed method for determining whether a parking space is available, characterized in that in at least one environment frame, at least one parking space area is preliminarily marked in order to obtain its layout coordinates, wherein the environment frame is obtained using at least one environmental sensor.

According to an exemplary embodiment of the present invention, there is provided a disclosed method for determining whether a parking space is available, characterized in that the layout coordinates of the parking space area are obtained by recognizing the parking space area in the environment frame and assigning the layout coordinates to the recognized parking space area, wherein the environment frame is obtained using at least one environmental sensor; and wherein the recognition of the parking space area and the assignment of layout coordinates to the recognized area are performed using a suitable neural network.

According to an exemplary embodiment of the present invention, there is provided a disclosed method for determining whether a parking space is available, characterized in that the environmental sensor is positioned so as to provide an overhead view of the environment frame.

According to an exemplary embodiment of the present invention, there is provided a disclosed method for determining whether a parking space is available, characterized in that the environmental sensor is positioned 3-18 meters above the parking space.

According to an exemplary embodiment of the present invention, there is provided a disclosed method for determining whether a parking space is available, characterized in that the environmental sensor is at least one of the lidar, sonar, radar, camera, or a combination thereof.

According to an exemplary embodiment of the present invention, there is provided a disclosed method for determining whether a parking space is available, characterized in that the vehicle outline coordinates are obtained using a neural network that is trained at least to provide the vehicle outline coordinates after the environment frame is inputted into it; wherein the coordinates of a key point of the vehicle outline are determined.

According to an exemplary embodiment of the present invention, there is provided a disclosed method for determining whether a parking space is available, characterized in that the key point of the vehicle outline is selected depending on an angle of the environment frame.

According to an exemplary embodiment of the present invention, there is provided a disclosed method for determining whether a parking space is available, characterized in that the key point of the vehicle outline is selected from a bottom left point of the vehicle outline and a bottom right point of the vehicle outline.

According to an exemplary embodiment of the present invention, there is provided a disclosed method for determining whether a parking space is available, characterized in that by matching the coordinates of the key point of the vehicle outline with the layout coordinates of the parking space area, a parking space availability signal is generated, wherein the parking space availability signal includes at least information that the parking space is occupied, if the coordinates of the key point of the vehicle outline are identified as lying within the layout coordinates of the parking space area.

According to another preferred embodiment of the present invention, there is provided a device for determining whether a parking space is available, comprising at least: one or more processors, and a memory that stores a program code which, when executed by the at least one processor, induces the at least one processor to perform a disclosed method for determining whether a parking space is available.

According to another preferred embodiment of the present invention, there is provided a system for determining whether a parking space is available, comprising at least: one or more disclosed environmental sensors adapted to obtain and transmit at least one disclosed environment frame and connected to at least one disclosed device for determining whether a parking space is available; one or more disclosed devices for determining whether a parking space is available, adapted to receive the at least one environment frame.

According to another preferred embodiment of the present invention, there is provided a machine-readable storage medium containing a program code, which, when executed by at least one processor of at least one computer device, allows to perform a disclosed method for determining whether a parking space is available.

According to another preferred embodiment of the present invention, there is provided a method for generating a graphical user interface, comprising at least the following steps: receiving a disclosed parking space availability signal; presenting, for displaying using an output device of a user device, at least one graphical element containing at least one area that is associated with a parking space, wherein the display of the at least one area depends on contents of the parking space availability signal.

According to another preferred embodiment of the present invention, there is provided a device for generating a graphical user interface, comprising at least: one or more processors; one or more output devices, at least one of which includes a visual information output device; one or more transceivers; and a memory that stores a program code which, when executed by the at least one processor of the device, allows to perform a disclosed method for generating a graphical user interface.

According to another preferred embodiment of the present invention, there is provided a system for generating a graphical user interface, comprising at least: one or more disclosed environmental sensors adapted to obtain and transmit at least one disclosed environment frame and connected to at least one disclosed device for determining whether a parking space is available; one or more disclosed devices for determining whether a parking space is available, adapted to receive the at least one environment frame, wherein said devices are at least adapted to generate and transmit a parking space availability signal; one or more disclosed devices for generating a graphical user interface, adapted to receive the parking space availability signal.

According to another preferred embodiment of the present invention, there is provided a machine-readable storage medium containing a program code, which, when executed by at least one processor of at least one computer device, allows to perform a disclosed method for generating a graphical user interface.

Additional alternative embodiments of the present invention are provided below. This disclosure is in no way limiting to the scope of protection granted by the present patent. Rather, it should be noted that the claimed invention can be implemented in different ways, so as to include different components and conditions, or combinations thereof, which are similar to the components and conditions disclosed herein, in combination with other existing and future technologies.

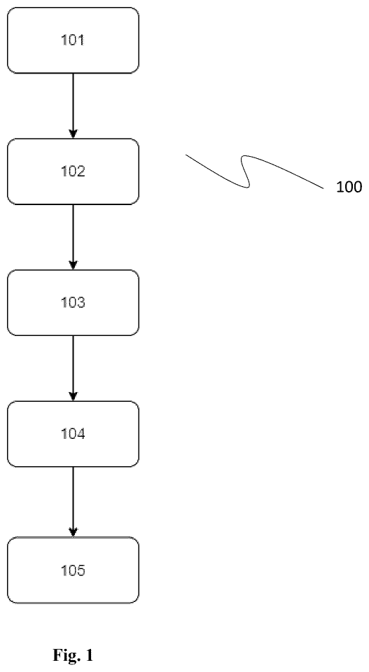

FIG. 1 illustrates an exemplary diagram for method 100 for determining whether a parking space is available. According to a preferred embodiment of the present invention, there is provided method 100 for determining whether a parking space is available, executed by at least one processor 2011 of at least one computer device 201, the method comprising at least the following steps: obtaining 101 environment frame 10; obtaining 102 layout coordinates 11 of a parking space area in environment frame 10; obtaining 103 vehicle outline coordinates 12 in environment frame 10; obtaining 104 coordinates 13 of a key point of the vehicle outline; and matching 105 coordinates 13 of the key point of the vehicle outline with layout coordinates 11 of the parking space area. In addition, preferably, but not limited to, in at least one environment frame 10, at least one parking space area is preliminarily marked in order to obtain its layout coordinates 11, wherein the environment frame is obtained using at least one environmental sensor 202; and wherein, but not limited to, environmental sensor 202, preferably, stays predominantly still, without changing its angle, preferably, so as not to change layout coordinates 11 of the parking space area that have been marked before. Preferably, but not limited to, environmental sensor 202 is one of the lidar, sonar, radar, camera, or a combination thereof. In addition, but not limited to, if environmental sensor 202 is a camera, then the environment frame is a video footage consisting of a plurality of frames obtained by shooting that provide a visual reproduction of the situation within the scope of the camera lens. In addition, but not limited to, if environmental sensor 202 is a lidar, a radar, or a sonar, then the environment frame is a cloud of dots that at least allows to render a 3D scene. In addition, it should be generally noted that an environmental sensor allows to constantly monitor at least one parking space, wherein, preferably, the environmental sensor's angle does not shift, i.e. the continuous flow of environment frames remains generally the same, so that the previously marked areas of each parking space are reproduced in relation to any single environment frame without changing, or at least without significantly changing, layout coordinates 11 for each parking space area. At the same time, it should be obvious to a person having ordinary skill in the art that environmental sensor 202 can be represented by any suitable combination of disclosed technical means, as long as the given combination allows to keep the flow of environment frames generally unchanged as well as at least to obtain the data for obtaining vehicle outline coordinates 12. In addition, but not limited to, layout coordinates 11 of the parking space area can be obtained by recognizing the parking space area in the environment frame and assigning layout coordinates 11 to the recognized parking space area, wherein the environment frame is obtained using at least one environmental sensor 202; and wherein the recognition of the parking space area and the assignment of layout coordinates 11 to the recognized area are performed using a suitable neural network, such as, but not limited to, a neural network that has been trained to determine coordinates of parking space areas using a set of environment frames. At the same time, but not limited to, in order to provide maximum accuracy for determining parking space areas, there may be provided a suitable software environment that provides a graphical user interface adapted to enable the user, by interacting with GUI elements, to mark parking space areas, which can result in obtaining layout coordinates 11 for each marked parking space area.

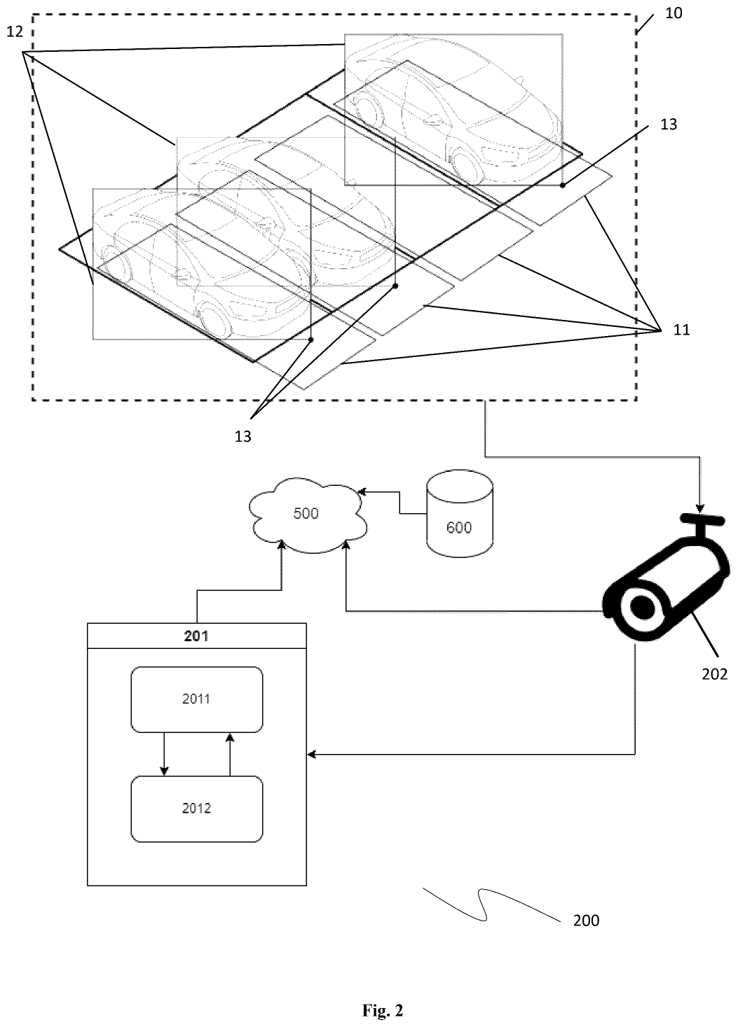

In addition, preferably, but not limited to, environmental sensor 202 is positioned so as to provide an overhead view of the environment frame, as shown in FIG. 2. For example, but not limited to, environmental sensor 202 is positioned approximately 3-18 meters above the parking space—preferably, 6-15 meters above the parking space. This is mainly determined by the fact that it is not preferable to monitor only one parking space, since a single environmental sensor 202 can cover multiple parking spaces at once, which allows to monitor and control the availability of a plurality of parking spaces at once. At the same time, if the configuration of a parking lot does not allow to place a single environmental sensor 202 so that it monitors all parking spaces in the lot, there may be placed an additional environmental sensor 202 to monitor parking spaces that fall into the blind spot of the first environmental sensor 202. In addition, preferably, but not limited to, each environmental sensor 202 is placed in such a way that each marked parking space area in each environment frame is not parallel to any of the axes of the rectangular coordinate system on the plane of the environment frame.

In addition, preferably, but not limited to, vehicle outline coordinates 12 are obtained using a neural network that is trained at least to provide vehicle outline coordinates 12 after the environment frame is inputted into it; wherein coordinates 13 of a key point of the vehicle outline are determined. In addition, but not limited to, the vehicle outline is a bounding box, usually a rectangular box drawn around a recognized object and characterized by at least two coordinates of diagonally positioned angles of the box. In addition, preferably, but not limited to, the neural network is trained at least to solve the classification problem in order to recognize vehicles and provide coordinates of their outlines. Preferably, but not limited to, for at least two camera angles, there are provided a pre-configuration that at least contains instructions about which of the points of the vehicle outline should be considered its key point. For example, but not limited to, if the angle of environmental sensor 202 and, consequently, of the resulting environment frame is selected as shown in FIG. 2, i.e. when, for example, but not limited to, the upper left corner of the marked parking space area is shifted counterclockwise in relation to at least the ordinate axis, then the bottom right key point of the vehicle outline should be considered the key point; and, conversely, but not limited to, when the upper right corner of the marked parking space area is shifted clockwise in relation to at least the ordinate axis, then the bottom left key point of the vehicle outline should be considered the key point; which, in a surprise discovery made by the inventor, allows to unambiguously identify any key point within the previously marked parking space area regardless of whether the parking has been performed correctly or the dimensions of the vehicle, which, therefore, can be anything from a motorcycle to a van. Therefore, but not limited to, by matching coordinates 13 of the key point of the vehicle outline with layout coordinates 11 of the parking space area, a parking space availability signal is generated, wherein the parking space availability signal includes at least information that the parking space is occupied, if coordinates 13 of the key point of the vehicle outline are identified as lying within layout coordinates 11 of the parking space area.

Therefore, but not limited to, according to another preferred embodiment of the present invention, there is provided device 201 for determining whether a parking space is available, comprising at least: one or more processors 2011, and memory 2012 that stores a program code which, when executed by the at least one processor 2011, induces the at least one processor 2011 to perform a disclosed method 100 for determining whether a parking space is available. Therefore, but not limited to, according to another preferred embodiment of the present invention, there is provided system 200 for determining whether a parking space is available, comprising at least: one or more disclosed environmental sensors 202 adapted to obtain and transmit at least one disclosed environment frame and connected to at least one disclosed device 201 for determining whether a parking space is available; and one or more disclosed devices 201 for determining whether a parking space is available, adapted to receive the at least one environment frame. In addition, preferably, but not limited to, communication between the devices within the system is provided using any suitable means, such as both wired and wireless communication, via one or more data exchange networks 500. At the same time, it should be obvious to a person having ordinary skill in the art that communication between devices 201 and environmental sensors 202 is provided using suitable interfaces and/or transceivers, which are considered inherent for the communicating devices within system 200, although not shown in the figures.

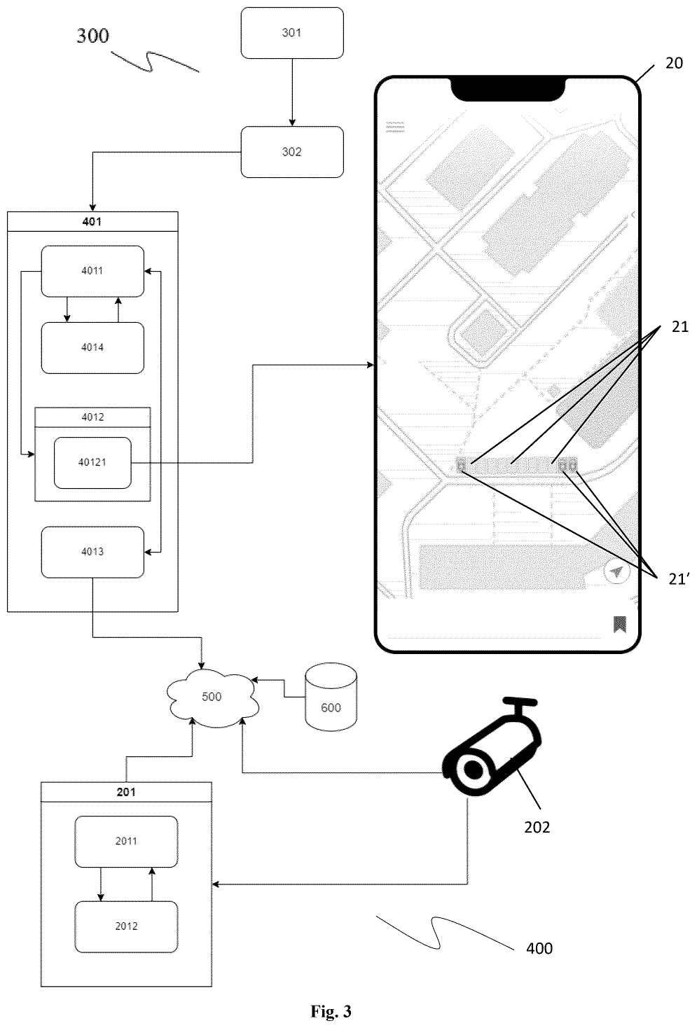

In addition, but not limited to, as shown in FIG. 3, there may be provided method 300 for generating a graphical user interface, comprising at least the following steps: receiving 301 a disclosed parking space availability signal; presenting 302, for displaying using output device 4012 of user device 401, at least one graphical element 20 containing at least one area 21 that is associated with a parking space, wherein the display of the at least one area 21 depends on contents of the parking space availability signal. For example, but not limited to, as shown in FIG. 3, a parking space availability signal has been received in relation to some areas 21—marked 21′ in FIG. 3 for better understanding—the signal containing information that parking spaces 21′ are occupied, and therefore they are displayed differently from parking spaces 21 when the graphical user interface is generated, which allows the user to quickly perceive which parking spaces are available and which are not.

Therefore, but not limited to, according to another preferred embodiment of the present invention, there is provided device 401 for generating a graphical user interface, which is a user device 401, comprising at least: one or more processors 4011; one or more output devices 4012, at least one of which includes a visual information output device 40121; one or more transceivers 4013; and memory 4014 that stores a program code which, when executed by the at least one processor of device 401, allows to perform a disclosed method for generating a graphical user interface. Therefore, but not limited to, according to another embodiment of the present invention, there is provided system 400 for generating a graphical user interface, comprising at least: one or more disclosed environmental sensors 202 adapted to obtain and transmit at least one disclosed environment frame and connected to at least one disclosed device 201 for determining whether a parking space is available; one or more disclosed devices 201 for determining whether a parking space is available, adapted to receive the at least one environment frame, wherein said devices 201 are at least adapted to generate and transmit a parking space availability signal; one or more disclosed devices 401 for generating a graphical user interface, adapted at least to receive the parking space availability signal.

Therefore, preferably, but not limited to, as shown in FIGS. 2, 4, there may be provided computer device 201, 401 that embodies, according to the present disclosure, at least one of the computer device for determining whether a parking space is available and computer device for generating a graphical user interface, or a combination thereof. Most typically, said computer device comprises at least one or more processors, and a memory that stores a corresponding program code as disclosed above. At the same time, said computer device can act as a corresponding server of a corresponding system that, therefore, also comprises at least one or more processors and a memory, which are, therefore, essentially identical to the processor(s) and the memory of the computer devices disclosed above, respectively. For example, but not limited to, the memory (computer-readable medium) may comprise a non-volatile memory (NVRAM); a random-access memory (RAM); a read-only memory (ROM); an electrically erasable programmable read-only memory (EEPROM); a flash drive or other memory technologies; a CD-ROM, a digital versatile disk (DVD) or other optical/holographic media; magnetic tapes, magnetic film, a hard disk drive or any other magnetic drive; and any other medium capable of storing and encoding the necessary information. In addition, but not limited to, the memory comprises a computer-readable medium based on the computer memory, either volatile or non-volatile, or a combination thereof. In addition, but not limited to, exemplary hardware devices include solid-state drives, hard disk drives, optical disk drives, etc. For instance, but not limited to, the computer-readable medium (memory) is not a temporary memory (i.e., a permanent, non-transitive memory), and therefore it does not contain a temporary (transitive) signal. In addition, but not limited to, the memory may store an approximate environment in which, using computer commands or codes, including those stored in the server's memory, any of the previously disclosed computer procedures, executed by the processor of the computer device, can be performed. In addition, but not limited to, the computer device, if it is not a thin client, contains one or more processors that are designed to execute computed commands or codes that are stored in the device's memory in order to perform the disclosed procedures. In addition, but not limited to, the server, essentially, can be similar to the computer device, if it is not a thin client, and, therefore, contain one or more processors that are designed to execute computed commands or codes that are stored in the server's memory in order to perform the disclosed procedures. In addition, but not limited to, any system disclosed herein may further comprise a database 600. Said database may be, but not limited to, a hierarchical database, a network database, a relational database, an object database, an object-oriented database, an object-relational database, a spatial database, a combination of two or more said databases, etc. In addition, but not limited to, the database at least stores data, parameters, raw data, marked-up data, modified data, machine learning models, and other information in its memory or a suitable memory of another computer device that is connected to any of the disclosed computer devices and/or the server, which may be, but not limited to, a memory that is similar to any of the disclosed memories, and which can be accessed via the server. In addition, but not limited to, there is provided a server, which, in addition to the functions mentioned above, stores and facilitates the execution of computer-readable commands and codes disclosed herein, which, accordingly, won't be described again. In addition, but not limited to, the server, in addition to the functions mentioned above, is capable of controlling the data exchange in the system. In addition, but not limited to, data exchange within the disclosed system is performed with the help of one or more data exchange networks 500. In addition, but not limited to, data exchange networks 500 may include, but not limited to, one or more local area networks (LAN) and/or wide area networks (WAN), or may be represented by the Internet or Intranet, or a virtual private network (VPN), or a combination thereof, etc. In addition, but not limited to, the server is further capable of providing a virtual computer environment for the components of the system to interact with each other. In addition, but not limited to, the network 500 is used to ensure interaction between the computer device, the server, optionally, the database, and, optionally, the systems mentioned above and other systems. In addition, but not limited to, the non-thin client computer device and/or server may be connected to the database directly, using wired or wireless communication methods, which are known in the art and therefore are not described in further detail, or, but not limited to, the database may be implemented in the memory of any computer device, including the server. In addition, but not limited to, a suitable non-thin client computer device can act as a system server for other computer devices, which are thin clients. In addition, but not limited to, most typically, the components of the computer devices disclosed herein and the server components are interconnected, including though some kind of data bus.

The present disclosure of the claimed invention demonstrates only certain exemplary embodiments of the invention, which by no means limit the scope of the claimed invention, meaning that it may be embodied in alternative forms that do not go beyond the scope of the present disclosure and which may be obvious to persons having ordinary skill in the art.

1. A non-transitory machine-readable storage medium containing a program code, which, when executed by at least one processor of at least one computer device, allows to perform a method for determining whether a parking space is available;
wherein the method for determining whether a parking space is available is executed by at least one processor of at least one computer device and comprises at least the following steps:
obtaining an environment frame;
obtaining layout coordinates of a parking space area in the environment frame;
obtaining vehicle outline coordinates in the environment frame;
obtaining coordinates of a key point of the vehicle outline; and
matching the coordinates of the key point of the vehicle outline with the layout coordinates of the parking space area.

2. The storage medium of claim 1, characterized in that in at least one environment frame, at least one parking space area is preliminarily marked in order to obtain its layout coordinates, wherein the environment frame is obtained using at least one environmental sensor.

3. The storage medium of claim 1, characterized in that the layout coordinates of the parking space area are obtained by recognizing the parking space area in the environment frame and assigning the layout coordinates to the recognized parking space area, wherein the environment frame is obtained using at least one environmental sensor; and wherein the recognition of the parking space area and the assignment of layout coordinates to the recognized area are performed using a suitable neural network.

4. The storage medium of any of the claims 2 or 3, characterized in that the environmental sensor is positioned so as to provide an overhead view of the environment frame.

5. The storage medium of claim 4, characterized in that the environmental sensor is positioned 3-18 meters above the parking space.

6. The storage medium of claim 5, characterized in that the environmental sensor is at least one of the lidar, sonar, radar, camera, or a combination thereof.

7. The storage medium of claim 1, characterized in that the vehicle outline coordinates are obtained using a neural network that is trained at least to provide the vehicle outline coordinates after the environment frame is inputted into it; wherein the coordinates of a key point of the vehicle outline are determined.

8. The storage medium of claim 7, characterized in that the key point of the vehicle outline is selected depending on an angle of the environment frame.

9. The storage medium of claim 8, characterized in that the key point of the vehicle outline is selected from a bottom left point of the vehicle outline and a bottom right point of the vehicle outline.

10. The storage medium of claim 1, characterized in that by matching the coordinates of the key point of the vehicle outline with the layout coordinates of the parking space area, a parking space availability signal is generated, wherein the parking space availability signal includes at least information that the parking space is occupied, if the coordinates of the key point of the vehicle outline are identified as lying within the layout coordinates of the parking space area.
